(19) United States
(12) Patent Application Publication
(10) Pub. No.: US 2007/0218299 A1
(43) Pub. Date: Sep. 20, 2007

(54) Thermosetting composition and film having a layer comprising the composition

(75) Inventor: Syuichi Azechi, Takasaki-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/724,287

(22) Filed: Mar. 15, 2007

(30) Foreign Application Priority Data
Mar. 17, 2006 (JP) 2006-075338

(51) Int. Cl. B32B 27/00; C08L 83/04; B32B 9/04

(52) U.S. Cl. 428/447; 525/474; 525/477; 525/478

(57) ABSTRACT

A thermosetting composition comprising (A) an organopolysiloxane and (B) a curing catalyst, characterized in that

the organopolysiloxane (A) has at least two alkenyl groups per molecule and a phenyl group in an amount of from 10 to 99% of whole substituents bonded to silicon atoms of the organopolysiloxane, and softens or melts at a temperature of from 30° C. to a temperature lower than an onset temperature of heat curing of the composition.

### CROSS REFERENCE TO RELATED APPLICATION

This application claimed the benefit of the Japanese Patent Application No. 2006-075338 filed on Mar. 17, 2006, the contents of which are incorporated by reference.

### FIELD OF THE INVENTION

The present invention relates to a thermosetting composition, specifically to a thermosetting composition comprising a base resin which softens or melts at a specific temperature range to provide a cured product without voids.

### PRIOR ART

A semiconductor device is usually prepared by the following steps: fixing a silicon wafer having a large-diameter to a dicing mount by bonding the wafer to a dicing tape fixed on the dicing mount; dicing the fixed silicon wafer in chips; picking up a chip by peeling the chip from the dicing tape; and bonding the chip to a lead flame with a liquid adhesive agent, so-called a die bonding agent.

Recently, to simplify the process and to prevent contamination of a semiconductor device caused by the liquid adhesive agent, a dicing and die bonding sheet is used which functions both as a dicing tape and as a die bonding agent.

A dicing and die bonding adhesive sheet should have such an adhesive layer that a silicon wafer is firmly held to the layer during the dicing process. The adhesive layer should be transferred from the sheet substrate to the rear of the chip when the chip is picked up. Then, in the die bonding process, the adhesive should be compression bonded to a lead frame and then cured to strongly fix the semiconductor chip to the lead frame.

Japanese Patent Application Laid-Open No. 9-67558 discloses an adhesive composition comprising a polyimide resin for a dicing and die bonding sheet. The polyimide resin, however, tends to weak at thermal stress due to its relatively high glass transition temperature (Tg) and high modulus of elasticity.

Japanese Patent Application Laid-Open No. 7-53871, 7-53942, and 7-70541 describe thermosetting silicone adhesives which have lower Tg and modulus of elasticity and functions as pressure sensitive adhesives. These adhesives cure at room temperature in the presence of moisture in the air. It takes from some days to some weeks for them to form a fully cured product having high adhesion strength, so that they are not appropriate for efficient production of semiconductor devices.

Japanese Patent Application Laid-Open No. 2005-53966 describes a silicone adhesive which is cured both by radial polymerization with peroxide and by a hydrosilylation reaction to form a cured product without voids.

However, the organopolysiloxane composition is not satisfactory in die attaching property, that is, a property which enables one to attach a thin semiconductor chip to a substrate at a pressure low enough not to break the thin chip.

### SUMMARY OF THE INVENTION

An object of the present invention is to provide an adhesive composition which can be bonded at low pressure and forms a cured product without voids.

The present invention is a thermosetting composition comprising (A) an organopolysiloxane and (B) a curing catalyst, characterized in that

the organopolysiloxane (A) has at least two alkenyl groups per molecule and a phenyl group in an amount of from 10 to 99% of whole substituents bonded to silicon atoms of the organopolysiloxane, and softens or melts at a temperature of from 30° C. to a temperature lower than an onset temperature of heat curing of the composition.

The aforesaid composition of the present invention softens or melts before hardening, so that it conforms to a contour of substrate with a wiring pattern formed thereon to which the composition is applied. Because no air bubbles are trapped between the composition and the substrate, a cured product without voids can be formed.

### BRIEF DESCRIPTION OF THE DRAWING

FIG. 1 is a differential scanning calorimetry chart of the composition prepared in Example 1 and that of a composition comprising all the components used in Example 1 but chloroplatinic acid catalyst.

### DESCRIPTION OF THE PREFERRED EMBODIMENTS

The organopolysiloxane (A) in the present composition has at least two alkenyl groups per molecule and phenyl groups bonded to silicon atoms in an amount of 10% or more of whole substituents bonded to silicon atoms, and softens or melts at a temperature of from 30 to 120° C. An example of the organopolysiloxane (A) is represented by the following average compositional formula (1):

R¹ₘR²ₙR³ₖSiO_{(4-m-n-k)/2} (1)

wherein, R¹ is a phenyl group, R³ is an alkenyl group, and R² is a group other than phenyl and alkenyl groups. From 10 to 99% of whole substituents are phenyl groups, that is, m/(m+n+k) is in the range of from 0.1 to 0.99.

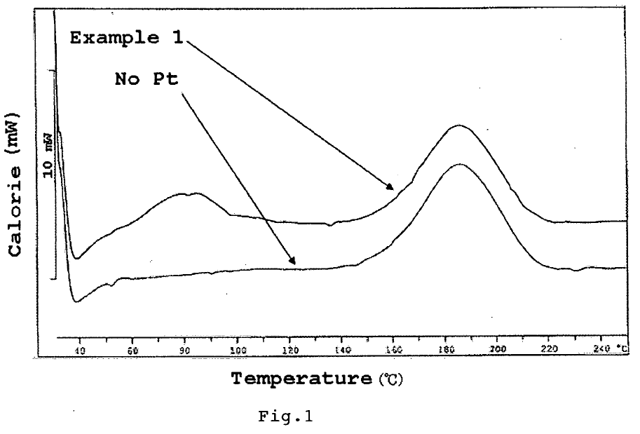

The organopolysiloxane (A) softens or melts at a temperature of from 30° C. to a temperature lower than an onset temperature of heat curing. The composition softens before thermally cured, so that it conforms to a contour of a substrate surface having a wiring pattern, preventing air bubbles from being entrapped. The onset temperature of heat curing can be determined by differential scanning calorimetry as a temperature at which temperature starts steeply rising due to an exothermic reaction. Typically, an onset temperature is 120° C. or higher, for example, 150° C. as shown in FIG. 1. In the present invention, a softening or melting temperature is measured by visually checking decrease in a viscosity of a predetermined amount of an organopolysiloxane placed on a hot plate drastically changes.

Preferably, the organopolysiloxane (A) has a weight average molecular weight reduced to polystyrene of from 410 to 10,000, more preferably from 600 to 10,000. Preferably, in the formula (1), m+n+k ranges from 0.9 to 2.8, more preferably from 1.1 to 2.6. Accordingly, m preferably ranges from 0.09(=0.9×0.1) to 2.78(=2.8×0.99), more preferably from 0.15 to 1.4. With an organopolysiloxane having m smaller than the aforesaid lower limit, it may be difficult to make a composition which softens or melts at a temperature of from 30° C. to a temperature lower than an onset temperature. In contrast, an organopolysiloxane having m larger than the aforesaid upper limit has a softening temperature too high to be used for die attaching at a low pressure.

In the formula (1), k which indicates an amount of alkenyl group (R³) is in the range of from larger than 0 to 0.5, preferably from 0.05 to 0.3, provided that at least two alkenyl group should be present per molecule. Preferred examples of the alkenyl group include those having 2 to 6 carbon atoms such as vinyl, allyl, and butenyl groups, among which vinyl group is preferred from industrial viewpoint.

R² is a monovalent group other than phenyl and alkenyl groups, such as a hydrogen atom, hydroxyl group, or hydrocarbon group. Preferred hydrocarbon groups have 1 to 6 carbon atoms, more preferably alkyl groups having 1 to 6 carbon atoms such as methyl, ethyl, propyl, butyl and hexyl groups and alkoxy groups having 1 to 4 carbon atoms. Among these, a methyl group is particularly preferred. In the formula (1), n ranges preferably from 0.2 to 2.5, more preferably from 0.5 to 2.1.

The organopolysiloxane (A) may be a mixture of two or more of the organopolysiloxanes. It may have a branched structure, i.e., T-unit and/or Q-unit.

The organopolysiloxane (A) can be prepared by a conventional method, for example, cohydrolyzing organochlorosilanes in the presence of alcohol having 1 to 4 carbon atoms and, then, removing hydrochloric acid formed and volatile materials. Alternatively, it can be prepared by polymerizing silanes having an organic group such as a phenyl or methyl group, and silicone oil or cyclic siloxane in the presence of hydrochloric acid, sulfuric acid or methanesulfonic acid and water for hydrolysis as needed, and removing the acid and volatile materials.

In the present invention, the curing catalyst (B) is used to polymerize alkenyl groups of the organopolysiloxane (A) and is preferably an organic peroxide. Examples of the organic peroxide include benzoyl peroxide, dicumyl peroxide, t-butyl benzoate t-butyl peroxy benzoate di-t-butyl peroxide, di-t-hexyl peroxide, t-butyl cumyl peroxide, 1,1-bis(t-butyl peroxy)3,3,5-trimethylcyclohexane, 2,5-dimethyl-2,5-bis(t-butyl peroxy)hexane, 1,6-bis(t-butyl peroxy carboxy)hexane, di-(4-methylbenzoyl)peroxide, -di-(2-methlbenzoyl) peroxide, t-butylperoxyisopropyl monocarbonate, and di-(2-t-butylperoxyisopropy) benzene. Preferably, an organic peroxide has a half life of 10 hours at a temperature of 90° C. or higher, more preferably 110° C. or higher. Examples of such organic peroxide include dicumylperoxide, di-t-butyl peroxide, di-t-hexylperoxide, t-butyl cumyl peroxide, 2,5-dimethyl-2,5-bis (t-butyl peroxy)hexane, and di-(2-t-butylperoxyisopropy) benzene.

The organic peroxide is incorporated in the composition in a catalytic amount which typically is in the range of from 0.1 to 20, more typically from 0.2 to 15, most typically from 0.5 to 10 parts by weight per 100 parts by weight of the organopolysiloxane (A). If the organic peroxide is used in an amount less than the aforesaid lower limit, sufficient crosslinking may not be obtained. Even if the organic peroxide is used in an amount more than the aforesaid upper limit, proportional improvement in properties may not be attained.

The present composition comprising the organopolysiloxane (A) and the curing catalyst (B) has a glass transition temperature (Tg) of 120° C. or lower. This temperature is significantly lower than that of a conventional polyimide composition to be able to relax thermal stress.

The present composition can further comprise (C) an organohydrogensiloxane and (D) an addition reaction catalyst. In that case, the composition is cured by an addition reaction of the organohydrogensiloxane (C) with the organopolysiloxane (A) in addition to the polymerization catalyzed by the peroxide described above. The organohydrogensiloxane (C) may have a linear, cyclic, branched or network structure. The organohydrogensiloxane (C) has at least two, preferably at least three, more preferably 2 to 500, most preferably 3 to 100 SiH bonds per molecule. An example of the organohydrogensiloxane (C) is represented by the following average compositional formula (2):

R⁴ₐH_{b}SiO_{(4-a-b)/2} (2)

wherein R⁴ is a hydrocarbon group other than aliphatic unsaturated group and preferably is a hydrocarbon group having 1 to 10 carbon atoms. Examples of R⁴ include alkyl groups such as methyl, ethyl, propyl, isopropyl, butyl, isobutyl, tert-butyl, pentyl, neopentyl, hexyl, cyclohexyl, octyl, nonyl, and decyl groups; aryl groups such as phenyl, tolyl, xylyl, and naphthyl groups; aralkyl groups such as benzyl, phenylethyl, and phenylpropyl groups; and halogenated groups thereof such as chloromethyl, chloropropyl, bromoethyl, and trifluoropropyl groups. Among these groups, alkyl groups and aryl groups are preferred, and methyl and phenyl groups are more preferred. For example, methylhydrogenpolysiloxane, dimethylsiloxane/methylhydrogensiloxane copolymer, and dimethylsiloxane/methylhydrogensiloxane/methylphenylsiloxane copolymer are used, which may be endcapped with trimethylsiloxy groups or dimethylhydrogensiloxy groups.

In the formula (2), a preferably ranges from 0.7 to 2.1, b ranges from 0.001 to 1.0 with a+b ranging from 0.8 to 3.0. More preferably, a ranges from 1.0 to 2.0, b ranges from 0.01 to 1.0 with a+b ranging from 1.5 to 2.5.

In the organohydrogensiloxane (C), SiH bond may be located at any site of a molecule. It may be located at an end and/or in the middle of a molecule. The organohydrogensiloxane (C) preferably has a degree of polymerization, i.e., a number of silicon atoms constituting a backbone of the molecule, of from 2 to 1,000, more preferably from 3 to 300, most preferably from 4 to 150. The organohydrogensiloxane (C) preferably has a viscosity of from 0.1 to 5,000 mPa·s, more preferably from 0.5 to 1,000 mPa·s at 25° C. Most preferably, the organohydrogensiloxane (C) is liquid having a viscosity of from 5 to 500 mPa·s at 25° C.

In the present composition, the organohydrogenpolysiloxane (C) is contained in such an amount that a molar ratio of its SiH bonds to alkenyl groups of the organopolysiloxane (A), i.e., (H/Vi), is in the range of from 0.01 to 0.7 mole/mole, preferably from 0.05 to 0.5 mole/mole. Such a composition becomes a pressure sensitive adhesive after the alkenyl groups react with the SiH bonds and, therefore, is suitably used for a dicing tape which prevents diced chips from being displaced or scattered during dicing process. If the ratio H/Vi is outside the aforesaid range, appropriate adhesiveness may not be attained.

The addition reaction catalyst (D) may be platinum, palladium, rhodium, or a compound thereof such as chloroplatinic acid, alcohol-modified chloroplatinic acid, a complexe of chloroplatinic acid with an olefin, vinylsiloxane, or acetylene compound, tetraquis(triphenylphosphine) palladium, or chlorotris(triphenyl phosphine) rhodium, among which platinum compounds are preferred.

The addition reaction catalyst (D) may be incorporated in the composition in an amount, as a catalytic metal, of from 1 to 500 ppm, preferably from 10 to 100 ppm based on a total weight of the composition.

The present composition may contain an inorganic filler. Example of the inorganic filler include silica fine powder, crystalline silica, pyrogenic spherical silica, hollow filler, sylsesquioxane, fumed titanium dioxide, magnesium oxide, zinc oxide, iron oxide, aluminum hydroxide, magnesium carbonate, calcium carbonate, zinc carbonate, layered mica, carbon black, diatomous earth, glass fiber. These filler may be treated with an organic silane compound such as an organoalkoxysilane, organochlorosilane, organosilazane, or a low-molecular weight siloxane compound. Silicone rubber powder or silicone resin powder may be used. Particularly, silica fine powder, crystalline silica, pyrogenic spherical silica, silicone rubber powder and silicone resin powder are effective to prevent warpage of a semiconductor package by decreasing a coefficient of volumetric expansion.

Particularly, silica fine powder is preferred. Preferably, the silica fine powder has a specific surface area measured by BET method of 50 m²/g or larger, more preferably of from 10 to 400 m²/g, most preferably of from 50 to 300 m²/g. Use may be made of silicone fine powder conventionally used to reinforce silicone rubber such as precipitated silica, fumed silica, pyrogenic silica and a mixture thereof. The silica fine powder can be used as it is, but preferably pretreated to have a hydrophobic surface for good flow property with silane coupling agents, for example, silazanes such as hexamethyldisilazane; methyltrimethoxysilane, ethyltrimethoxysilane, propyltrimethoxysilane, butyltrimethoxysilane, dimethyldimethoxysilane, diethyldimethoxysilane, vinyltriethoxysilane, vinyltrimethoxysilane, trimethylmethoxysilane, triethylmethoxysilane, vinyltris(methoxyethoxy)silane, trimethylchlorosilane, dimethyldichlorosilane, divinyldimethoxysilane, chlropropyltrimethoxysilane; or an organic silicon compound such as polymethylsiloxane and organohydrogenpolysiloxane.

The organic filler is incorporated in the composition in an amount of from 1 to 50 parts by weight, preferably from 1 to 30 parts by weight, per 100 parts by weight of the organopolysiloxane (A).

When the present composition is used as an adhesive, the composition preferably contains (E) an adhesive aid. Preferred examples of the adhesive aid include organic compounds, organic silicon compounds, organic titanium compounds and a mixture thereof, each having specific functional groups.

Examples of the organic silicon compounds include organosilane compounds having one, preferably two, functional group selected from alkenyl groups such as vinyl and allyl groups; epoxy groups such as γ-glycydoxypropyl, and β-(3,4-epoxycyclohexyl) ethyl groups; (meth)acryl groups such as γ-acryloxypropyl and γ-methacryloxypropyl groups; alkoxy groups such as methoxy, ethoxy, propoxy, and buthoxy groups; alkoxysilyl groups such as trimethoxysilyl, triethoxysilyl, and methyldimethoxysilyl groups; isocyanate group and SiH bond. Also included are linear or cyclic siloxane oligomers having 3 to 50, particularly 5 to 20 silicon atoms; and alkoxysilyl triallylisocyanurate and siloxan derivatives thereof. The examples of the silicon compounds are illustrated below.

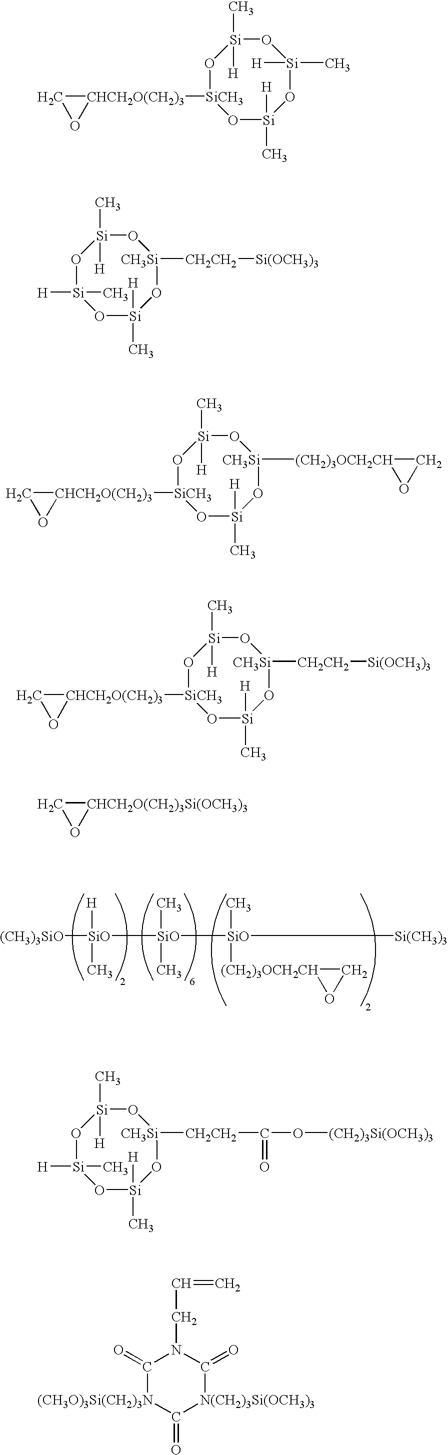

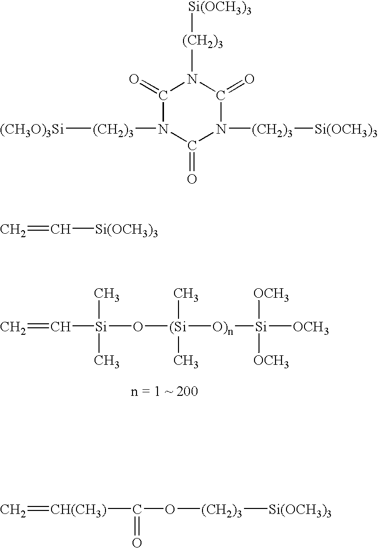

Examples of the organic titanium compounds include tetra-i-propyl titanate, tetra-n-buyl titanate, butyl titanate dimer, tetrastearyl titanate, triethanolamine titanate, titanium acetyl acetonate, titnium ethyl acetoacetate, titanium lactate, and octylglycol titanate, isopropyltristearoyl titanate, isopropyltridecylbenzene sulfonyl titanate, isopropyltris(dioctylpyrophosphate) titanate, bis(dioctylpyrophosphate) oxyacetate titanate, bis(dioctylpyrophosphate) ethylene titanate, tetrabutoxy titanium, tetrakis(2-ethylhyxyloxy) titanium, tetrakisallyoxy titanium, titanium stearate, tetraoctyloxy titanium, titanium-i-propoxyoctylene glycolate, titanium ethyl acetonate; and oligomers or polymers thereof.

Examples of the organic compounds include organic compounds having at least one alkenyl group and an ester group per molecule, for example, ally esters of unsaturated carboxylic acids, for example, acrylic acid, methacrylic acid and vinyl acetic acid; and allyl esters such as allyl benzoate, diallyl phthalate, pyromellitic acid tetraallyl ester, and allyl esters of alkyl acids.

Other examples include organic compounds or organic silicon compounds which have a phenylene backbone and at least two functional groups selected from epoxy, alkenyl and hydroxyl groups as shown below:

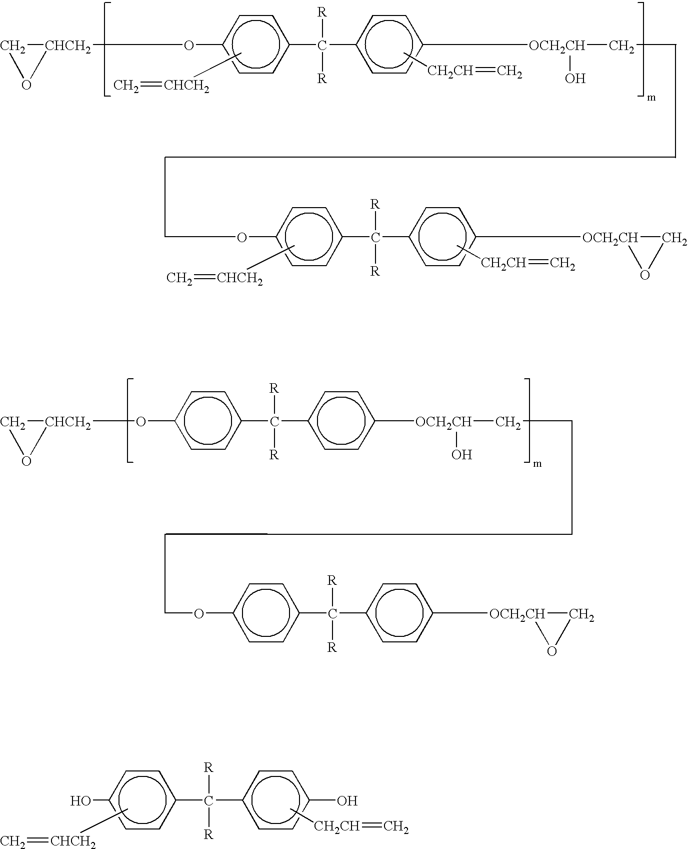

wherein R is a hydrogen atom or an alkyl group having 1 to 3 carbon atoms, and m is an integer of from 0 to 16;

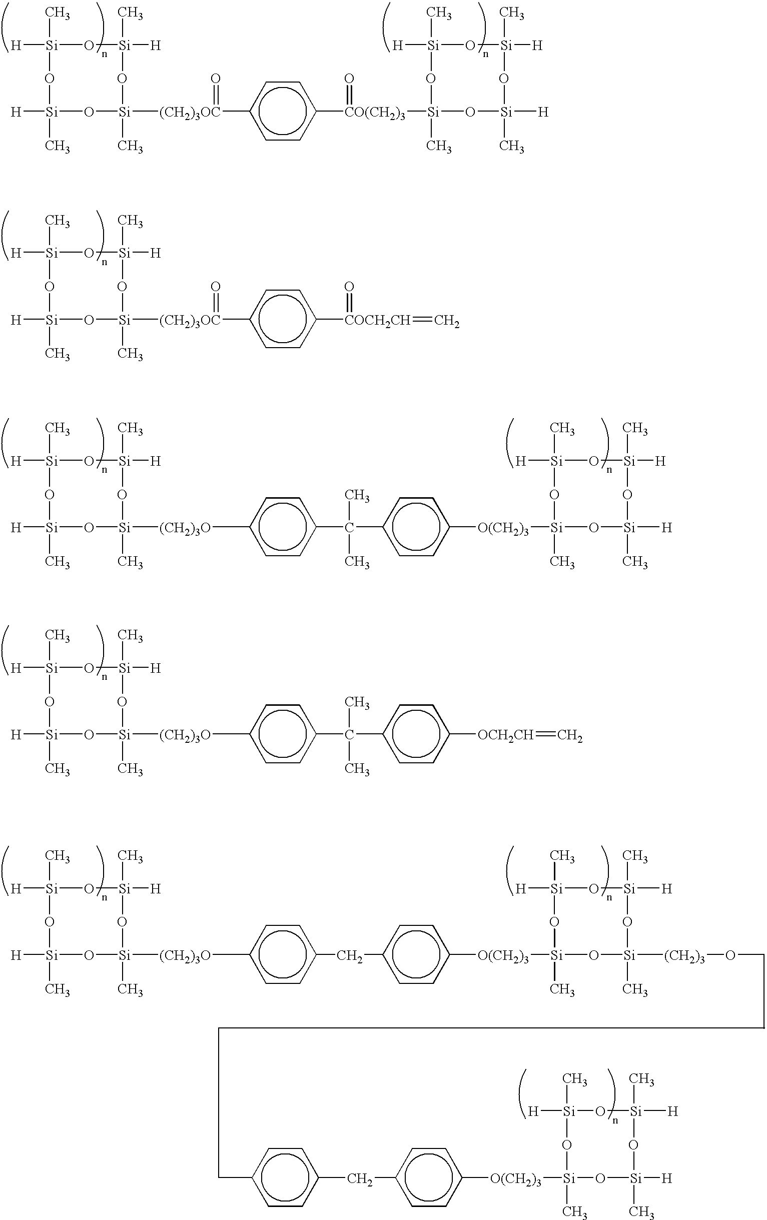

wherein n is an integer of from 1 to 4;

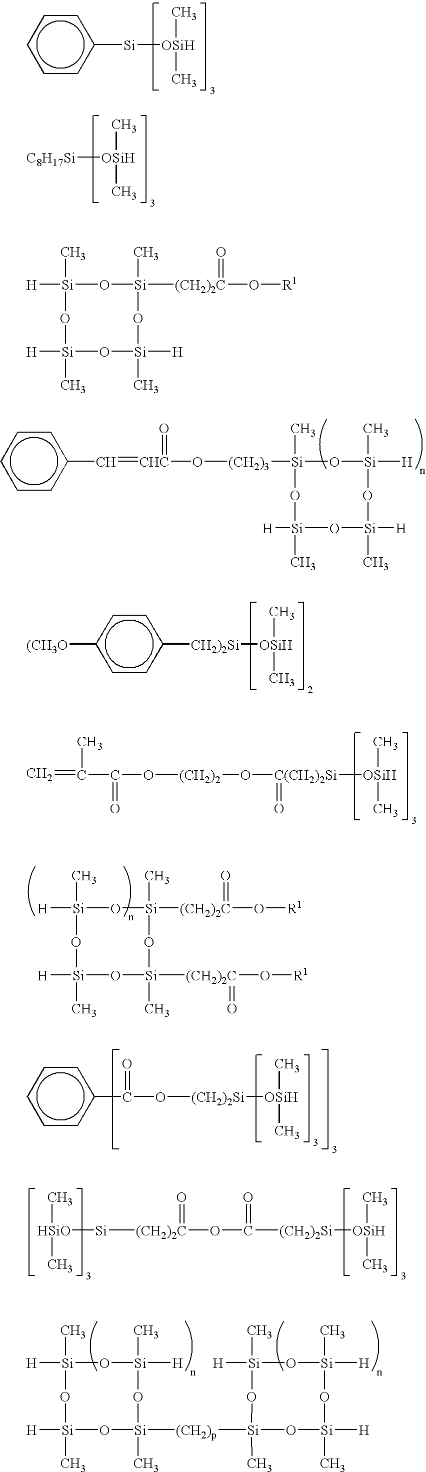

wherein n is an integer of from 1 to 4, p is an integer of from 2 to 30, and R¹ is a hydrogen atom or an alkyl group having 1 to 3 carbon atoms;

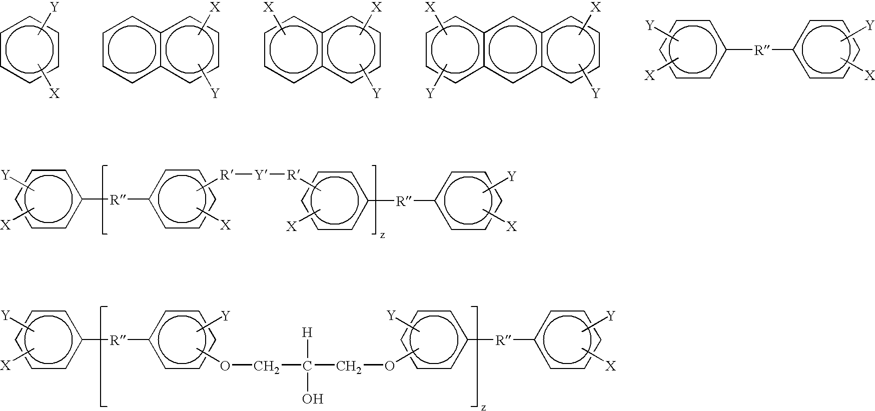

wherein X is:

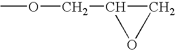

Y is one of the following groups:

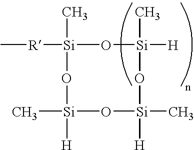

wherein n is an integer of from 1 to 4,

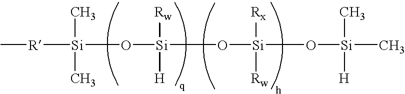

R′ is one of the following groups:

Rw and Rx is a monovalent hydrocarbon groups, q ranges from 1 to 50, preferably from 1 to 20, and h ranges from 0 to 100, preferably from 1 to 40, R″ is one of the following groups

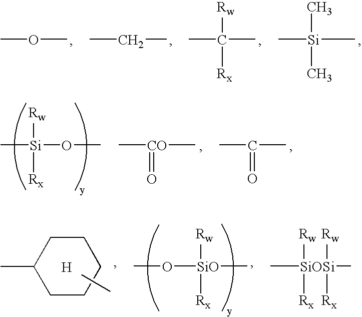

Rw and Rx are as defined above and y ranges from 0 to 100.

The above compounds may have an alkoxysilyl group such as trimethoxysilyl, triethoxysilyl, or methyldimethoxysilyl group, acryl group, methacryl group, ester group, a carboxylic acid anhydride group, isocyanate group, amino group or amide group.

In the above formulas, Rw and Rx preferably have 1 to 12, more preferably 1 to 8 carbon atoms. Examples of Rw and Rx include alkyl, aryl, aralkyl, alkenyl, alkoxy, acryl, methacryl, acryloyl, methacryloyl, amino, alkylamino groups whose hydrogen atoms may be replaced with substituents.

The adhesive aid (E) having an epoxy group preferably has an epoxy equivalent of from 100 to 5,000 g/mol, particularly from 150 to 3,000 g/mol. If it has an epoxy equivalent smaller than the aforesaid lower limit, it may decrease viscosity of the composition. If it has an epoxy equivalent larger than the aforesaid upper limit, it may decrease adhesion strength of the composition. Together with the adhesive aid (E) having an epoxy group, use may be made of a ring opening catalyst for an epoxy compound such as organic metal chelates, amine compounds, amido compounds, imidazol compounds, and acid anhydrides.

The adhesive aid (E) may be used in an amount of from 0.1 to 20 parts, preferably from 0.5 to 15 parts by weight per 100 parts by weight of the organopolysiloxane (A), or a total 100 parts by weight of the components (A) and (C), if the organohydrogenpolysiloxane (C) is used. If the amount is below the aforesaid lower limit, sufficient adhesion strength may not be attained. If the amount exceeds the aforesaid upper limit, a cost performance of such a composition may not be good.

The present composition may further contain (F) an organopolysiloxane resin to improve adhesion strength. In the present invention, the term “resin” means a semi-solid or solid polymer at room temperature. The organopolysiloxane resin can improve, depending on material of a wafer and/or a die frame, adhesion strength and transfer property of a pressure sensitive adhesive sheet of the present invention.

The component (F) is an organopolysiloxane resin or a mixture thereof having a R⁵₃SiO_{1/2} unit, hereinafter referred to as M-unit, and a SiO₂ unit, hereinafter referred to as Q-unit, with a ratio of M-unit/Q-unit ranging from 0.6 to 1.7, preferably from 0.6 to 1.0. An organopolysiloxane resin with a M-unit/Q-unit ratio smaller than the aforesaid lower limit may decrease adhesion strength or tackiness of an adhesion film and the one with the ratio higher than the aforesaid upper limit may also decrease adhesion strength. Preferably, R⁵ is a hydrocarbon group having 1 to 10, more preferably from 1 to 6 carbon atoms. Examples of R⁵ include alkyl groups such as methyl, ethyl, propyl, and butyl groups; cycloalkyl groups such as a cyclohexyl group; aryl groups such as a phenyl group; and alkenyl groups such as vinyl, allyl, and hexenyl groups, among which methyl group is preferred.

The organopolysiloxane resin (F) may have a hydroxyl group bonded to a silicon atom, i.e., silanol group. The silanol group is preferably present in an amount of from about 0.02 to 0.05 mole % of whole substituent groups of the organopolysiloxane resin (F). An organopolysiloxane resin having silanol groups more than the aforesaid upper limit may interfere heat curing of a composition.

The organopolysiloxane resin (F) may have relatively small amount of R⁵SiO_{3/2} unit and/or R⁵₂SiO unit, wherein R⁵ is as defined above, as far as they do not adversely affect properties of the present composition.

Preferred organopolysiloxane resin (F) has (CH₃)₃SiO_{1/2} unit and SiO₂ unit with a molar ratio of (CH₃)₃SiO_{1/2} unit/SiO₂ unit of 1/0.75 mole/mole and about 1 mole % of hydroxyl group.

The present composition may contain an organopolysiloxane other than the aforesaid components (A) and (F). The organopolysiloxane preferably has at least two on average alkenyl groups per molecule and may be represented by the following formula:

R⁶ₐSiO_{(4-a)/2}

wherein R⁶ is a monovalent hydrocarbon group having 1 to 12 carbon atoms, which may be substituted and at least 1.0×10⁻⁵ mole %, preferably at least 1.0×10⁻⁴ mole %, more preferably at least 0.01 mole % and at most 20 mole %, particularly at most 10 mole % of R⁶ is alkenyl group, and a is a number of from 1.5 to 2.8.

R⁶ is a monovalent hydrocarbon group having 1 to 12, preferably from 1 to 8 carbon atoms, which may be substituted. Examples of R⁶ include alkyl groups such as methyl, ethyl, propyl, isopropyl, butyl, isobutyl, tert-butyl, pentyl, neopentyl, hexyl, cyclohexyl, octyl, nonyl, and decyl groups; and alkenyl groups such as vinyl, ally, propenyl, isopropenyl, butenyl, isobutenyl, hexenyl, cyclohexenyl, and octenyl groups. R⁶ may be a mixture of these groups, but there are at least two alkenyl groups per molecule.

The present composition may contain other optional components such as organic solvents, inhibitor of creep hardening, plasticizers, thixotropic agents, pigments, dyes, and fungicide. Preferably, the present composition is diluted with an organic solvent when it is to be applied on a film substrate. Examples of the organic solvent include toluene, xylene, hexane, heptane, ethanol, isopropanol, acetone, and methyl ethyl ketone. An amount of the solvent depends on an intended viscosity of the composition, but is typically in the range of from 20 to 90 parts by weight, more typically from 30 to 80 parts by weight per total 100 parts by weight of the composition.

When the composition contains an addition catalyst (D), it may further contain a retarder for retarding an addition reaction. Examples of the retarder include phosphorous containing compounds such as triphenylphosphine, nitrogen-containing compounds such as tributyl amine, tetramethylethylenediamine, and benzotriazole, sulfur-containing compounds, acetylene devivatives, compounds having two or more of alkenyl groups, hydroperoxy compounds, and maleic acid derivatives. Retardation effect of these compounds widely differs depending on their chemical structure and therefore their optimum contents in the composition should be determined individually.

The present composition can be prepared by mixing aforesaid components. The silicone components and the inorganic filler may be mixed by heating first and, then, other components are added at room temperature. The composition obtained can be used as a pressure sensitive adhesive in its uncured state or in a state after completion of a hydrosilylation reaction when the components (C) and (D) are contained. The pressure sensitive adhesive adheres to various kinds of substrates. For example, in a dicing process of a semiconductor device manufacturing, the pressure sensitive adhesive is held on a dicing mount and a silicon wafer is bonded to the pressure sensitive adhesive.

The present composition can be used as a thermosetting adhesive whose cured product adheres strongly to a substrate. For example, in a die bonding process of a semiconductor device manufacturing, a semiconductor chip to which a pressure sensitive adhesive layer composed of the composition is attached is bonded to a lead frame and then heated, which produces a semiconductor chip strongly bonded to the lead frame with the cured adhesive. The present composition can be used consecutively in the dicing process and die bonding processes.

When the present composition is used as a thermosetting adhesive, the composition is applied to a substrate and an adhesive layer having an appropriate thickness is formed by drying when a volatile solvent is contained in the composition. Then, an object such as a silicon wafer is pressure bonded to the adhesive layer. Subsequently, the adhesive layer and the bonded object may be diced, if necessary. In a subsequent process, the adhesive layer is cured by heated.

The present composition can be used in an adhesive film which is made by applying the composition to a film substrate. The film may be a plastic film such as polyethylene, polypropylene, polyester, polyamide, polyimide, polyamideimide, polyetherimide, or polytetrafluoroethylene film, paper, or metal foil. The substrate film may be pretreated with a release agent in order for the adhesive layer to be easily transferred from the film in a pick-up process.

The present composition is applied on the film and dried, when a volatile composition is contained to form a layer. A thickness of the layer can be set according to an intended use of the layer, but typically ranges from 0.01 to 2.0 mm. When the components (C) and (D) are contained in the layer, the layer is heated to be a pressure sensitive adhesive layer at a temperature which is high enough for an addition reaction to occur, but not so high for heat curing to occur. If desired, a release film as a protective film is pressure bonded to the pressure sensitive adhesive layer to form a three-layered film. The film may be wound up in a roll for better handling.

The film thus prepared may be used as follows: the adhesive layer is bonded to an object and, then, the substrate film is removed. To an exposed surface of the pressure sensitive adhesive layer, another object to be adhered is bonded and fixed. When the film has a protective release film, the release film is peeled off first and, to an exposed adhesive, an object is pressure bonded and fixed.

A solvent in the composition may be dried usually at room temperature for 2 hours or longer, or at a temperature of from 40 to 130° C. for 1 to 20 minutes, preferably at a temperature of from 50 to 120° C. for 1 to 20 minutes. Drying may be performed simultaneously with an addition reaction, but a temperature range should be controlled not to induce curing by organic peroxide.

Heating may be performed at a temperature where the curing catalyst (B) is active, which is typically in the range of from 100 to 250° C. for 15 to 60 minutes, preferably from 120 to 230° C. for 15 to 60 minutes.

A substrate or an object to be bonded to the present composition may be a metal such as Fe, Al, Cr, Ni, Si, Cu, Ag, or Au; inorganic material or ceramic such as glass, silicon nitride, or silicon carbide; or an organic material such as epoxy, phenol, polyimide, polyamide, polyester, or silicone resin.

A film consisting of three layers, i.e, a substrate film, an adhesive layer laminated on the release film and a release film laminated on the adhesive layer, can be used both for dicing and die bonding process, allowing efficient manufacturing of semiconductor devices. In a first step, a dicing mount is made ready on which the substrate film is bonded. In the second step, the release film is peeled off and, to the exposed surface of the adhesive layer, a silicon wafer is bonded. Then, the silicon wafer is diced in chips. Subsequently, each silicon chip is picked up with the adhesive layer bonded to the chip is transferred from the substrate film.

Then, the chip is bonded to a lead frame via the adhesive layer followed by heating to cure the adhesive. In this way, a semiconductor device is efficiently manufactured.

### EXAMPLES

The present invention is further explained with reference to the examples, but not limited thereto. In the following, the term “part” means parts by weight and a viscosity was measured at 25° C. unless otherwise specified.

The following adhesive aids (i) to (vi) were used.

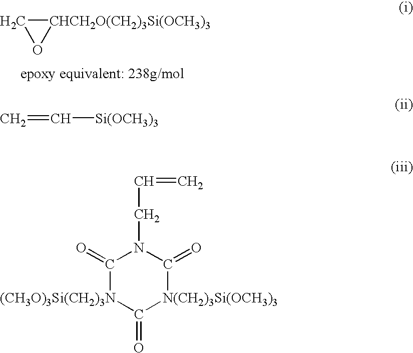

(iv) KBE9007 (Isocyanate silane, ex Shin-Etsu Chemical Co., Ltd)

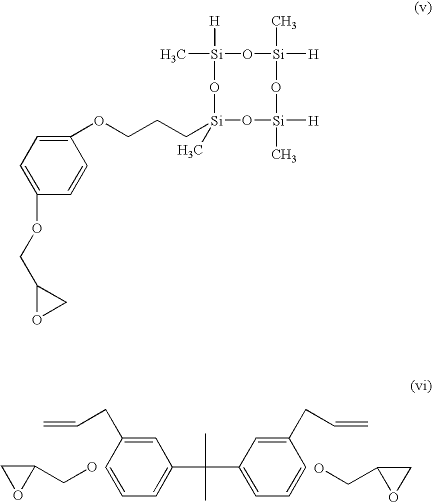

### Example 1

A composition was prepared by mixing 70 parts of an organopolysiloxane which is represented by the following average compositional formula and has a softening point of 40° C.,

(C₆H₅)_{0.9}(CH₃)_{0.2}(CH₂═CH)_{0.2}SiO_{1.35}

20 parts by silica having trimethylsilylated hydrophobic surface and a specific surface area of 120 m²/g, a dimethylsiloxane/methylhydrogensiloxane copolymer which has SiH bonds at both ends and at a branch in an amount of 0.54 weight % and viscosity of 12 mPa·s in such an amount that a molar ratio of SiH/Vinyl, hereinafter referred to as H/Vi, of 0.3 mole/mole, 30 ppm as platinum metal, based on a total weight of the composition, of a chloroplatinic acid complex with divinyltetramethyldisiloxane, 5 parts per 100 parts of the aforesaid organopolysiloxane of di-(2-t-butylperoxyisopropyl)benzene, 1.5 parts of the adhesive aid (i), 1-ethynylcyclohexanol, and toluene in such an amount that a total weight % of the components other than toluene was 30 wt %. In all of the examples, an amount of 1-ethynylcyclohexanol was such that an addition reaction substantially completes at 80° C. for 10 minutes. The composition was cured at 170° C. for 60 minutes. The cured product thus obtained had a glass transition temperature of 46° C. which was determined from volumetric expansion coefficient measured with a viscoelastometer.

### Example 2

A composition was prepared in the same manner as in Example 1 except that an organopolysiloxane which is represented by the following formula and has a softening point of 53° C.,

(C₆H₅)_{0.89}(CH₃)_{0.28}(CH₂═CH)_{0.28}SiO_{1.28}

and the adhesive aid (ii) were used. A cured product had a glass transition temperature of 60° C.

### Example 3

A composition was prepared in the same manner as in Example 1 except that an organopolysiloxane which is represented by the following formula and has a softening point of 47° C.,

(C₆H₅)_{1.10}(CH₃)_{0.25}(CH₂═CH)_{0.05}SiO_{1.30}

and the adhesive aid (iii) were used. A cured product had a glass transition temperature of 60° C.

### Example 4

A composition was prepared in the same manner as in Example 1 except that an organopolysiloxane which is represented by the following formula and has a softening point of 53° C.,

(C₆H₅)_{0.6}(CH₃)_{0.35}(CH₂═CH)_{0.25}SiO_{1.15}

a diphenylsiloxane/dimethylsiloxane/methylhydrogensiloxane copolymer which has a viscosity of 12 mPa·s, SiH bonds at both ends and at a branch in an amount of 0.34 wt % and 30 mole % of phenyl groups in place of the aforesaid dimethylsiloxane/methylhydrogensiloxane copolymer, and the adhesive aid (iv) in place of the adhesive aid (i) were used. A cured product had a glass transition temperature of 57° C.

### Example 5

A composition was prepared in the same manner as in Example 4 except that the organopolysiloxane used in the Example 2 and the adhesive aid (v) were used. A cured product had a glass transition temperature of 50° C.

### Example 6

A composition was prepared in the same manner as in Example 4 except that an organopolysiloxane which is represented by the following formula and has a softening point of 55° C.

(C₆H₅)_{0.89}(CH₃)_{0.27}(OH)_{0.01}(CH₂═CH)_{0.27}SiO_{1.28}

and the adhesive aid (vi) were used. A cured product had a glass transition temperature of 61° C.

### Example 7

A composition was prepared in the same manner as in Example 6 except that an organopolysiloxane which is represented by the following formula and has a softening point of 55° C.,

(C₆H₅)_{1.09}(CH₃)_{0.29}(OH)_{0.02}(CH₂═CH)_{0.27}SiO_{1.16}

a diphenylsiloxane/dimethylsiloxane/methylhydrogensiloxane copolymer which has a viscosity of 12 mPa·s, SiH bonds at both ends and at a branch in an amount of 0.5 wt % and 30 mole % of phenyl groups, and the adhesive aid (v) were used. A cured product had a glass transition temperature of 35° C.

### Example 8

A composition was prepared by mixing 100 parts of an organopolysiloxane which is represented by the following formula and has a softening point of 50° C.,

(C₆H₅)_{0.85}(CH₃)_{0.25}(CH₂═CH)_{0.05}SiO_{1.43}

5 parts of di-(2-t-butylperoxyisopropyl)benzene, 1.5 parts of the adhesive aid (v), and toluene in such an amount that a total weight % of the components other than toluene was 30 wt %. A cured product obtained by curing the composition at 170° C. for 60 minutes had a glass transition temperature of 46° C.

### Example 9

A composition was prepared in the same manner as in Example 6 except that an organopolysiloxane which is represented by the following formula and has a softening point of 40° C. was used.

(C₆H₅)_{0.9}(CH₃)_{0.2}(CH₂═CH)_{0.2}SiO_{1.35}

A cured product had a glass transition temperature of 46° C.

### Comparative Example 1

A composition was prepared in the same manner as in Example 1 except that an organopolysiloxane which is represented by the following formula

(CH₃)_{1.17}(CH₂═CH)_{0.27}SiO_{1.28}

and the adhesive aid (iii) were used. A cured product had a glass transition temperature of −10° C.

### Comparative Example 2

A composition was prepared in the same manner as in Comparative Example 1 except that an organopolysiloxane which is represented by the following formula

(CH₃)_{1.27}(CH₂═CH)_{0.27}SiO_{1.23}

and the adhesive aid (v) were used. A cured product had a glass transition temperature of −20° C.

### Referential Example 1

A composition was prepared in the same manner as in Example 2 except that no adhesive aid was used. A cured product had a glass transition temperature of 60° C.

### Comparative Example 3

A composition was prepared by mixing 70 parts of an organopolysiloxane oil which has a degree of polymerization of 10,000, methyl groups at both ends, 30 mole % of phenyl groups, and vinyl groups in an amount of 0.005 mole per 100 g, 20 parts of an organosiloxane which has alkenyl and phenyl groups and is represented by the formula,

(C₆H₅)_{0.6}(CH₃)_{1.3}(CH₂═CH)_{0.13}SiO_{0.985}

20 parts by silica having trimethylsilylated hydrophobic surface and a specific surface area of 120 m²/g, a diphenylsiloxane/dimethylsiloxane/methylhydrogensiloxane copolymer which has SiH bonds at both ends and at a branch in an amount of 0.34 wt % and 30 mole % of phenyl groups in such an amount that a molar ratio of H/Vi is 0.35 mole/mole, 1-ethynylcyclohexanol, 30 ppm as platinum metal, based on a total weight of the composition, of a chloroplatinic acid complex with divinyltetramethyldisiloxane, 5 parts per 100 parts of the aforesaid organopolysiloxane of di-(2-t-butylperoxyisopropyl)benzene, 3 parts of the adhesive aid (iii), and toluene in such an amount that a total weight % of the components other than toluene was 30 wt %. A cured product of the composition had a glass transition temperature of −40° C.

Each composition prepared was applied to a 50 μm-thick PET film coated with a fluorinated silicone releasing agent and, then, left at room temperature for 10 minutes followed by heating at 80° C. for 10 minutes to form an about 50 μm-thick adhesive layer. By heating, the composition hardened through an addition reaction except the composition prepared in Example 8.

### Transfer Property

A silicon wafer having a diameter of 8 inches and a thickness of 300 μm was bonded to a PET film with an adhesive layer formed thereon, hereinafter referred to as an adhesive PET film. Then, the wafer with the adhesive PET film bonded thereto was diced with a dicer, ex. Disco Co., into 10 mm×10 mm square chips. Then, the chips were picked up. In the picking up procedure, a composition was rated as “A” when the adhesive layer made of the composition was transferred from the PET substrate film to the picked up chips, otherwise “B.”

### Chip Displacement

A silicon wafer having a diameter of 8 inches and a thickness of 300 μm with an adhesive PET film attached thereto was diced into 10 mm×10 mm square chips. Then, the chips were subjected to an air blowing for 5 minutes followed by an aqueous cleaning for 5 minutes while rotating the wafer at 3000 rpm. When no chip was displaced either by the blowing or cleaning, an adhesive was rated as “A” otherwise “B.”

### Chip Scattering

In the aforesaid chip displacement test, an adhesive was rated as “A” when no chip was scattered by the blowing and cleaning otherwise “B.”

### Adhesion Strength

An adhesive layer of an adhesive PET film was bonded to an end with a size of 10 mm×25 mm of a SUS test piece. From the bonded adhesive PET film, PET substrate film was peeled off. On the exposed adhesive layer, an end of a BT resin substrate coated with UV-curable solder resist, PSR4000 AUS308, ex Taiyo Ink Manufacturing Co., was bonded, whereby the adhesive layer was sandwiched, on which a load of 2000 g was applied for 1 minute. Then, the test piece thus prepared was heated at 170° C. for 60 minutes to cure the adhesive. Subsequently, the bonded test piece was subjected to a shear adhesion strength (kg/cm²) measurement according to JIS K6850, using a shear adhesion strength meter.

### Durability of Adhesion Strength

A bonded test piece obtained as above was kept in an environment of a temperature of 80° C. and a relative humidity of 90% for 7 days and, then, subjected to the shear adhesion strength measurement as described above.

### Thermal Deformation Property

A chip diced in the transfer property test was attached to a unit substrate as used in the adhesion strength test. Then, the test piece thus obtained was placed on a hot plate kept at 120° C. and a pressure of 0.1 MPa was applied to the test piece from above. The adhesive layer was visually observed whether it deformed or not. Subsequently, a temperature of the hot plate was raised to 170° C. to cure the adhesive. After cooled to room temperature, the cured adhesive was observed with an ultrasonic tester. An adhesive showing no void was rated as “A” and the one with a void was rated as “B.”

TABLE 1

| | | | | | | | | | | Ref. | Comparative | | |
|---|---|---|---|---|---|---|---|---|---|---|---|---|---|
| | Example | | | | | | | | | Ex.*¹ | Example | | |
| | 1 | 2 | 3 | 4 | 5 | 6 | 7 | 8 | 9 | 1 | 1 | 2 | 3 |
| Transfer Property | A | A | A | A | A | A | A | A | A | A | A | B | A |
| Chip displacement | A | A | A | A | A | A | A | A | A | A | A | B | B |
| Chip scattering | A | A | A | A | A | A | A | A | A | A | A | B | B |
| Adhesion strength | 60 | 60 | 60 | 59 | 67 | 66 | 62 | 57 | 62 | 3 | 62 | 57 | 60 |
| Durability of | 60 | 60 | 60 | 57 | 67 | 66 | 60 | 57 | 60 | 3 | 60 | 57 | 60 |
| adhesion | | | | | | | | | | | | | |
| Thermal | A | A | A | A | A | A | A | A | A | A | B | B | B |
| deformation | | | | | | | | | | | | | |

*¹Referential Example

As shown in Table 1, the compositions of Examples had good thermal deforming property and formed cured products without voids. In contrast, compositions of the comparative examples hardened without thermally deformed before hardened, to form cured products with voids.

The cured products in Examples showed superior adhesion strength. The composition of Referential Example 1 did not comprise an adhesive aid, resulting in low adhesion strength of a cured product. However, it can be used as a pressure sensitive adhesive.

1. A thermosetting composition comprising (A) an organopolysiloxane and (B) a curing catalyst, characterized in that
the organopolysiloxane (A) has at least two alkenyl groups per molecule and a phenyl group in an amount of from 10 to 99% of whole substituents bonded to silicon atoms of the organopolysiloxane, and softens or melts at a temperature of from 30° C. to a temperature lower than an onset temperature of heat curing of the composition.

2. The composition according to claim 1, wherein the curing catalyst (B) is an organic peroxide having a half life of 10 hours at a temperature of 90° C. or higher and the onset temperature of the heat curing of the composition is 150° C. or higher.

3. The composition according to claim 1, wherein a cured product of the composition has a glass transition temperature of 120° C. or lower.

4. The composition according to claim 1, wherein the composition further comprises (C) an organohydrogensiloxane having at least two SiH bonds per molecule and (D) an addition reaction catalyst.

5. The composition according to claim 4, wherein the organohydrogensiloxane (C) is contained in such an amount that a molar ratio of its SiH bonds to the alkenyl groups of the organopolysiloxane (A) is in the range of from 0.01 to 0.7 mole/mole.

6. The composition according to claim 1, wherein the composition further comprises (E) an adhesive aid selected from the group consisting of organic compounds, organic silicon compounds and organic titanium compounds all having at least two groups selected from the group consisting of alkenyl, epoxy, alkoxysilyl, acryl, methacryl, ester, carboxylic acid anhydride, isocyanate, amino and amide groups.

7. The composition according to claim 1, wherein the composition further comprises an inorganic filler.

8. A film having a layer comprising the composition according to any one of claims 1 to 7 on at least one side.

9. A semiconductor device comprising a cured product of the composition according to any one of claims 1 to 7.
